(19) United States
(12) Patent Application Publication
(10) Pub. No.: US 2013/0296450 A1
(43) Pub. Date: Nov. 7, 2013

(54) METHOD FOR PRODUCING POLYETHER CARBONATE POLYOLS HAVING PRIMARY HYDROXYL END GROUPS AND POLYURETHANE POLYMERS PRODUCED THEREFROM

(71) Applicants: Jörg Hofmann, Krefeld (DE); Christoph Gürtler, Koln (DE); Hartmut Nefzger, Pulheim (DE); Norbert Hahn, Frechen (DE); Klaus Lorenz, Dormagen (DE); Thomas Ernst Müller, Munchen (DE)

(72) Inventors: Jörg Hofmann, Krefeld (DE); Christoph Gürtler, Koln (DE); Hartmut Nefzger, Pulheim (DE); Norbert Hahn, Frechen (DE); Klaus Lorenz, Dormagen (DE); Thomas Ernst Müller, Munchen (DE)

(73) Assignee: Bayer Intellectual Property GmbH, Monheim (DE)

(21) Appl. No.: 13/994,449

(22) PCT Filed: Dec. 12, 2011
(86) PCT No.: PCT/EP2011/072489

§ 371 Date: Jul. 16, 2013

(30) Foreign Application Priority Data
Dec. 17, 2010 (EP) 10195634.0

(51) Int. Cl. C08G 64/34; C08G 18/48; C08G 64/02

(52) U.S. Cl. CPC C08G 64/34; C08G 64/0208; C08G 18/4887
USPC 521/157; 528/274; 525/437; 525/440.04

(57) ABSTRACT

The present invention relates to a process for the preparation of polyether carbonate polyols with primary hydroxyl end groups, comprising the steps of reaction of a starter compound containing active hydrogen atoms with an epoxide and carbon dioxide under double metal cyanide catalysis, reaction of the product obtained with a cyclic carboxylic acid anhydride and reaction of this product obtained with ethylene oxide in the presence of a catalyst which contains at least one nitrogen atom per molecule, excluding non-cyclic tertiary amines with identical substituents. The invention furthermore relates to polyether carbonate polyols obtainable by this process, compositions comprising these polyether carbonate polyols and polyurethane polymers based on these polyether carbonate polyols.

The present invention relates to a process for the preparation of polyether carbonate polyols with primary hydroxyl end groups, comprising the steps of reaction of a starter compound containing active hydrogen atoms with an epoxide and carbon dioxide under double metal cyanide catalysis, reaction of the product obtained with a cyclic carboxylic acid anhydride and reaction of this product obtained with ethylene oxide in the presence of a catalyst which contains at least one nitrogen atom per molecule, excluding non-cyclic tertiary amines with identical substituents. The invention furthermore relates to polyether carbonate polyols obtainable by this process, compositions comprising these polyols and polyurethane polymers based on these polyols.

Long-chain polyether polyols prepared by double metal cyanide catalysis (DMC catalysis) are also called IMPACT polyethers. They contain predominantly secondary hydroxyl end groups due to the system. The use of ethylene oxide/propylene oxide mixtures (EO/PO) is possible only up to a certain content of EO; long-chain polyether polyols with predominantly primary hydroxyl end groups are thus not accessible by the impact process. Instead, such polyethers are obtained either by a procedure in which catalysis is carried out exclusively by conventional base catalysis (for example KOH), or in a two-stage procedure in which an EO end block is polymerized on to an IMPACT-PO polyether obtained by means of DMC catalysis, optionally a PO/EO copolyether or a polyether containing PO/EO mixed end blocks.

The KOH process generally has the disadvantage that this catalyst must be separated off in an expensive manner, for example by neutralization and filtration. Furthermore, undesirable olefinic end groups are formed as by-products, especially in the case of long-chain polyethers. Such olefinic end groups or allyl ether end groups reduce the functionality of these polyethers and make their use in certain applications difficult. They also lead to polyurethane (PU) products of poorer quality.

The preparation of polyether carbonate polyols by catalytic reaction of alkylene oxides (epoxides) and carbon dioxide in the presence or absence of H-functional starter substances (starters) has been investigated intensively for more than 40 years (e.g. Inoue et al., Copolymerization of Carbon Dioxide and Epoxide with Organometallic Compounds; Die Makromolekulare Chemie 130, 210-220, 1969). This reaction e.g. using an H-functional starter compound is shown in diagram form in equation (I), wherein R represents an organic radical, such as alkyl, alkylaryl or aryl, each of which can also contain hetero atoms, such as, for example, O, S, Si etc., and wherein e and f represent an integer, and wherein the product shown for the polyether carbonate polyol in equation (I) is merely to be understood as meaning that blocks with the structure shown can in principle be found in the polyether carbonate polyol obtained, but the sequence, number and length of the blocks and the OH functionality of the starter can vary and is not limited to the polyether carbonate polyol shown in equation (I). This reaction (see equation (I)) is ecologically very advantageous, since this reaction represents the conversion of a greenhouse gas, such as CO₂, into a polymer. The cyclic carbonate (for example for R═CH₃ propylene carbonate) shown in formula (I) is formed as a further product, actually a by-product.

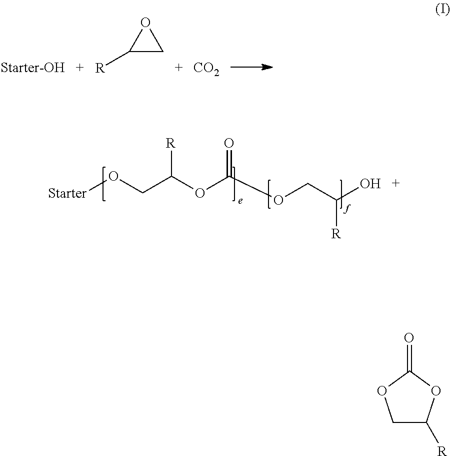

U.S. Pat. No. 4,487,853 discloses a process for the preparation of a polyether ester polyol with a high content of primary hydroxyl groups. In this process, a) the reaction product of a condensate of a polyol with an alkylene oxide is reacted with a cyclic carboxylic anhydride and b) ethylene oxide at a temperature of 50° C. to 125° C. The condensate is obtained from a polyol having 2 to 8 hydroxyl groups and an equivalent weight of from 30 to 45 and an alkylene oxide having 2 to 4 carbon atoms and mixtures thereof. The condensate has an equivalent weight of from 500 to 10,000. After reaction with the cyclic carboxylic acid anhydride, a half-ester is obtained. The reaction of a) with ethylene oxide takes place in the presence of an active amount of an amine, oxide or divalent metal catalyst. The ratio of the equivalents of the anhydride to the equivalents of the condensate is in the range of from approximately 1:1 to approximately 1:2 and the molar ratio of ethylene oxide to anhydride is in the range of from approximately 2:1 to approximately 1.5:1. A polyurethane from the reaction of an organic polyisocyanate with such polyols is furthermore disclosed. However, U.S. Pat. No. 4,487,853 does not describe how polyether polyols prepared under DMC catalysis can be converted into polyols with primary hydroxyl end groups with an outlay on the process which is as low as possible.

There consequently continues to be a need for preparation processes for polyether carbonate polyols with primary hydroxyl end groups, and in particular for such processes which convert polyether carbonates prepared by DMC catalysis.

It has been found, surprisingly, that the object can be achieved by a process for the preparation of polyether carbonate polyols with primary hydroxyl end groups, comprising the steps:
1. reaction of a starter compound containing active hydrogen atoms with carbon dioxide and with at least one epoxide (alkylene oxide) of the general formula (II):

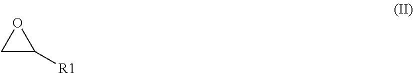

wherein R1 represents hydrogen, an alkyl radical or an aryl radical and with the proviso that ≧0% by weight to ≦30% by weight, based on the total amount of the epoxide (II) employed, is ethylene oxide,
   wherein the reaction is carried out in the presence of a double metal cyanide catalyst (DMC catalyst) and wherein preferably the crude product of this reaction undergoes no further purification with the exception of a possible distillation step;
2. reaction of the product obtained in step 1, with a cyclic carboxylic acid anhydride; and
3. reaction of the product obtained in step 2. with ethylene oxide in the presence of a catalyst which contains at least one nitrogen atom per molecule, excluding non-cyclic tertiary amines with identical substituents.

One advantage of the process according to the invention is that polyether carbonate polyols prepared under DMC catalysis, which even at high average molecular weights show no or a technical insignificant deviation of the actual OH functionality from the ideal OH functionality, react to give polyether carbonate polyols with a relatively high content of primary hydroxyl end groups (in the following also abbreviated to “primary OH groups”). Since removal of the catalyst after the first step is omitted, a simplification of the overall process can be achieved.

Starter compounds containing active hydrogen atoms (also called H-functional starter substance) which are employed in step 1. are preferably compounds with (number-average) molecular weights of from ≧18 g/mol to ≦2,000 g/mol, preferably ≧62 g/mol to ≦2,000 g/mol, and with a number of hydroxyl groups per molecule of from ≧1 to ≦8, preferably ≧2 to ≦4. Examples of these are ethylene glycol, diethylene glycol, triethylene glycol, 1,2-propylene glycol, dipropylene glycol, 1,4-butanediol, hexamethylene glycol, bisphenol A, bisphenol F, trimethylolpropane, glycerol, castor oil, pentaerythritol, sorbitol, sucrose, cane sugar, degraded starch and/or water.

H-functional starter substances (starter compounds) which are particularly preferably employed in step 1. are those compounds with number-average molecular weights of from ≧450 g/mol to ≦2,000 g/mol or a mixture of a) compounds with number-average molecular weights of from ≧62 g/mol to ≦450 g/mol (also called “low molecular weight starter compounds in the following) and b) compounds with number-average molecular weights of from ≧450 g/mol to ≦2,000 g/mol (also called “starter polyols” in the following), which preferably each contain ≧1 to ≦8, preferably ≧2 to ≦5 hydroxyl groups.

Examples of low molecular weight starter compounds are ethylene glycol, diethylene glycol, triethylene glycol, 1,2-propylene glycol, dipropylene glycol, 1,4-butanediol, hexamethylene glycol, bisphenol A, bisphenol F, trimethylolpropane, glycerol, castor oil, pentaerythritol, sorbitol and/or cane sugar. Examples of starter polyols are, for example, polyether polyols, which have been prepared, for example, from the abovementioned low molecular weight starter compounds and epoxides, or poly(oxyalkylene) carbonate polyols, which have been prepared, for example, from the abovementioned starter compounds, epoxides and CO₂, these starter polyols each having number-average molecular weights of from ≧450 g/mol to ≦2,000 g/mol.

The epoxide of the general formula (II) is preferably a terminal epoxide with a substituent R1, which can be hydrogen, an alkyl radical or an aryl radical. In connection with the overall invention, the term “alkyl” generally includes substituents from the group of n-alkyl, such as methyl, ethyl or propyl, branched alkyl and/or cycloalkyl. In connection with the overall invention, the term “aryl” generally includes substituents from the group of mononuclear carbo- or heteroaryl substituents, such as phenyl, and/or polynuclear carbo- or heteroaryl substituents. It is possible that mixtures of various epoxides can also be employed in the process according to the invention, as long as the constituents of the epoxide mixture all fall under the general formula (II). If mixtures of various epoxides are used, it is also possible to modify the mixture ratio of the epoxides stepwise or continuously during the metering. Generally, epoxides having 2-24 carbon atoms can be employed for the process according to the invention. The alkylene oxides having 2-24 carbon atoms are, for example, one or more compounds chosen from the group consisting of ethylene oxide, propylene oxide, 1-butene oxide, 2,3-butene oxide, 2-methyl-1,2-propene oxide (isobutene oxide), 1-pentene oxide, 2,3-pentene oxide, 2-methyl-1,2-butene oxide, 3-methyl-1,2-butene oxide, 1-hexene oxide, 2,3-hexene oxide, 3,4-hexene oxide, 2-methyl-1,2-pentene oxide, 4-methyl-1,2-pentene oxide, 2-ethyl-1,2-butene oxide, 1-heptene oxide, 1-octene oxide, 1-nonene oxide, 1-decene oxide, 1-undecene oxide, 1-dodecene oxide, 4-methyl-1,2-pentene oxide, butadiene monoxide, isoprene monoxide, cyclopentene oxide, cyclohexene oxide, cycloheptene oxide, cyclooctene oxide, styrene oxide, methylstyrene oxide, pinene oxide, mono- or polyepoxidized fats as mono-, di- and triglycerides, epoxidized fatty acids, C₁-C₂₄ esters of epoxidized fatty acids, epichlorohydrin, glycidol, and derivatives of glycidol, such as, for example, methyl glycidyl ether, ethyl glycidyl ether, 2-ethylhexyl glycidyl ether, allyl glycidyl ether, glycidyl methacrylate and epoxide-functional alkyloxysilanes, such as, for example, 3-glycidyloxypropyltrimethoxysilane, 3-glycidyloxypropyltriethoxysilane, 3-glycidyloxypropyltripropoxysilane, 3-glycidyloxypropylmethyldimethoxysilane, 3-glycidyloxypropylethyldiethoxysilane and 3-glycidyloxypropyltriisopropoxysilane, in each case with the proviso that ≧0% by weight to ≦30% by weight, based on the total amount of epoxide (II) employed, is ethylene oxide. Preferably, ≧0% by weight to ≦30% by weight (based on the total amount of epoxide (I) employed) of ethylene oxide and ≧30% by weight to ≦100% by weight (based on the total amount of epoxide (II) employed) of propylene oxide, particularly preferably pure propylene oxide, are employed as alkylene oxides.

The double metal cyanide catalysts (DMC catalysts) which are suitable for step 1. (copolymerization) of the process according to the invention are known in principle from the prior art (see e.g. U.S. Pat. No. 3,404,109, U.S. Pat. No. 3,829,505, U.S. Pat. No. 3,941,849 and U.S. Pat. No. 5,158,922). DMC catalysts, which are described e.g. in U.S. Pat. No. 5,470,813, EP-A 700 949, EP-A 743 093, EP-A 761 708, WO 97/40086, WO 98/16310 and WO 00/47649, have a very high activity in the homopolymerization of epoxides and render possible the preparation of polyether polyols at very low catalyst concentrations (25 ppm or less), so that in general it is no longer necessary to separate off the catalyst from the finished product. The highly active DMC catalysts described in EP-A 700 949, which, in addition to a double metal cyanide compound (e.g. zinc hexacyanocobaltate(III)) and an organic complexing ligand (e.g. tert-butanol), also contain a polyether with a number-average molecular weight of greater than 500 g/mol, are a typical example.

It is also possible to employ the alkaline DMC catalysts disclosed in EP application no. 10163170.3.

Cyanide-free metal salts which are suitable for the preparation of the double metal cyanide compounds preferably have the general formula (III)

M(X)ₙ (III)

wherein
M is chosen from the metal cations Zn²⁺, Fe²⁺, Ni²⁺, Mn²⁺, Co²⁺, Sr²⁺, Sn²⁺, Pb²⁺ and, Cu²⁺, preferably M is Zn²⁺, Fe²⁺, Co²⁺ or Ni²⁺,
X are one or more (i.e. different) anions, preferably an anion chosen from the group of halides (i.e. fluoride, chloride, bromide, iodide), hydroxide, sulfate, carbonate, cyanate, thiocyanate, isocyanate, isothiocyanate, carboxylate, oxalate and nitrate;
n is 1 if X=sulfate, carbonate or oxalate and
n is 2 if X=halide, hydroxide, cyanate, thiocyanate, isocyanate, isothiocyanate or nitrate,
or suitable cyanide-free metal salts have the general formula (IV)

Mᵣ(X)₃ (IV)

wherein
M is chosen from the metal cations Fe³⁺, Al³⁺ and Cr³⁺,
X are one or more (i.e. different) anions, preferably an anion chosen from the group of halides (i.e. fluoride, chloride, bromide, iodide), hydroxide, sulfate, carbonate, cyanate, thiocyanate, isocyanate, isothiocyanate, carboxylate, oxalate and nitrate;
r is 2 if X=sulfate, carbonate or oxalate and
r is 1 if X=halide, hydroxide, cyanate, thiocyanate, isocyanate, isothiocyanate, carboxylate or

nitrate,

or suitable cyanide-free metal salts have the general formula (V)

M(X)ₛ (V)

wherein
M is chosen from the metal cations Mo⁴⁺, V⁴⁺ and W⁴⁺
X are one or more (i.e. different) anions, preferably an anion chosen from the group of halides (i.e. fluoride, chloride, bromide, iodide), hydroxide, sulfate, carbonate, cyanate, thiocyanate, isocyanate, isothiocyanate, carboxylate, oxalate and nitrate;
s is 2 if X=sulfate, carbonate or oxalate and
s is 4 if X=halide, hydroxide, cyanate, thiocyanate, isocyanate, isothiocyanate, carboxylate or nitrate,
or suitable cyanide-free metal salts have the general formula (VI)

M(X)ₜ (VI)

wherein
M is chosen from the metal cations Mo⁶⁺ and W⁶⁺
X are one or more (i.e. different) anions, preferably an anion chosen from the group of halides (i.e. fluoride, chloride, bromide, iodide), hydroxide, sulfate, carbonate, cyanate, thiocyanate, isocyanate, isothiocyanate, carboxylate, oxalate and nitrate;
t is 3 if X=sulfate, carbonate or oxalate and
t is 6 if X=halide, hydroxide, cyanate, thiocyanate, isocyanate, isothiocyanate, carboxylate or nitrate.

Examples of suitable cyanide-free metal salts are zinc chloride, zinc bromide, zinc iodide, zinc acetate, zinc acetylacetonate, zinc benzoate, zinc nitrate, iron(II) sulfate, iron(II) bromide, iron(II) chloride, cobalt(II) chloride, cobalt(II) thiocyanate, nickel(II) chloride and nickel(II) nitrate. Mixtures of various metal salts can also be employed.

Metal cyanide salts which are suitable for the preparation of the double metal cyanide compounds preferably have the general formula (VII)

(Y)ₐM′(CN)_{b}(A)_{c} (VII)

wherein
M′ is chosen from one or more metal cations of the group consisting of Fe(II), Fe(III), Co(II), Co(III), Cr(II), Cr(III), Mn(II), Mn(III), h(III), Ni(II), Rh(III), Ru(II), V(IV) and V(V), preferably
M′ is one or more metal cations of the group consisting of Co(II), Co(III), Fe(II), Fe(III), Cr(III), Ir(III) and NO),
Y is chosen from one or more metal cations of the group consisting of alkali metal (i.e. Li⁺, Na⁺, K⁺, Rb⁺, Cs⁺) and alkaline earth metal (i.e. Be²⁺, Ca²⁺, Mg²⁺, Sr²⁺, Ba²⁺),
A is chosen from one or more anions of the group consisting of halides (i.e. fluoride, chloride, bromide, iodide), hydroxide, sulfate, carbonate, cyanate, thiocyanate, isocyanate, isothiocyanate, carboxylate, oxalate or nitrate and
a, b and c are integers, wherein the values for a, b and c are chosen such that the metal cyanide salt has electroneutrality; a is preferably 1, 2, 3 or 4; b is preferably 4, 5 or 6; c preferably has the value 0.

Examples of suitable metal cyanide salts are potassium hexacyanocobaltate(III), potassium hexacyanoferrate(II), potassium hexacyanoferrate(III), calcium hexacyanocobaltate(III) and lithium hexacyanocobaltate(III).

Preferred double metal cyanide compounds which the DMC catalysts according to the invention contain are compounds of the general formula (VIII)

Mₓ[M′_{x′}(CN)_{y}]_{z} (VIII)

wherein M is as defined in formula (III) to (VI) and
M′ is as defined in formula (VII), and
x, x′, y and z are integers and are chosen such that the double metal cyanide compound has electroneutrality.

### Preferably

x=3, x′=1, y=6 and z=2,

### M=Zn(II), Fe(II), Co(II) or Ni(II) and

### M′=Co(III), Fe(III), Cr(III) or Ir(III).

Examples of suitable double metal cyanide compounds are zinc hexacyanocobaltate(III), zinc hexacyanoiridate(III), zinc hexacyanoferrate(III) and cobalt(II) hexacyanocobaltate(III). Further examples of suitable double metal cyanide compounds are to be found e.g. in U.S. Pat. No. 5,158,922 (column 8, lines 29-66). Zinc cyanocobaltate(III) is particularly preferably used.

The organic complexing ligands added in the preparation of the DMC catalysts are disclosed, for example, in U.S. Pat. No. 5,158,922 (see in particular column 6, lines 9 to 65), U.S. Pat. No. 3,404,109, U.S. Pat. No. 3,829,505, U.S. Pat. No. 3,941,849, EP-A 700 949, EP-A 761 708, JP 4 145 123, U.S. Pat. No. 5,470,813, EP-A 743 093 and WO-A 97/40086. For example, water-soluble, organic compounds with hetero atoms, such as oxygen, nitrogen, phosphorus or sulfur, which can form complexes with the double metal cyanide compound are employed as organic complexing ligands. Preferred organic complexing ligands are alcohols, aldehydes, ketones, ethers, esters, amides, ureas, nitriles, sulfides and mixtures thereof. Particularly preferred organic complexing ligands are aliphatic ethers (such as dimethoxyethane), water-soluble aliphatic alcohols (such as ethanol, isopropanol, n-butanol, iso-butanol, sec-butanol, tert-butanol, 2-methyl-3-buten-2-ol and 2-methyl-3-butyn-2-ol), and compounds which contain both aliphatic or cycloaliphatic ether groups and aliphatic hydroxyl groups (such as e.g. ethylene glycol mono-tert-butyl ether, diethylene glycol mono-tert-butyl ether, tripropylene glycol monomethyl ether and 3-methyl-3-oxetane-methanol. Organic complexing ligands which are most preferred are chosen from one or more compounds of the group consisting of dimethoxyethane, tert-butanol, 2-methyl-3-buten-2-ol, 2-methyl-3-butyn-2-ol, ethylene glycol mono-tert-butyl ether and 3-methyl-3-oxetane-methanol.

One ore more complexing component(s) from the compound classes of polyethers, polyesters, polycarbonates, polyalkylene glycol sorbitan esters, polyalkylene glycol glycidyl ethers, polyacrylamide, poly(acrylamide-co-acrylic acid), polyacrylic acid, poly(acrylic acid-co-maleic acid), polyacrylonitrile, polyalkyl acrylates, polyalkyl methacrylates, polyvinyl methyl ether, polyvinyl ethyl ether, polyvinyl acetate, polyvinyl alcohol, poly-N-vinylpyrrolidone, poly(N-vinylpyrrolidone-co-acrylic acid), polyvinyl methyl ketone, poly(4-vinylphenol), poly(acrylic acid-co-styrene), oxazoline polymers, polyalkyleneimines, maleic acid and maleic anhydride copolymers, hydroxyethylcellulose and polyacetals, or the glycidyl ethers, glycosides, carboxylic acid esters of polyfunctional alcohols, bile acids or salts, esters or amides thereof, cyclodextrins, phosphorus compounds, α,β-unsaturated carboxylic acid esters or ionic surface- or interface-active compounds are optionally employed in the preparation of the DMC catalysts.

Preferably, in the first step in the preparation of the DMC catalysts, the aqueous solutions of the metal salt (e.g. zinc chloride), employed in a stoichiometric excess (at least 50 mol %), based on the metal cyanide salt (that is to say at least a molar ratio of cyanide-free metal salt to metal cyanide salt of 2.25 to 1.00) and of the metal cyanide salt (e.g. potassium hexacyanocobaltate) are reacted in the presence of the organic complexing ligands (e.g. tert-butanol), so that a suspension which contains the double metal cyanide compound (e.g. zinc hexacyanocobaltate), water, excess cyanide-free metal salt and the organic complexing ligand is formed. In this context, the organic complexing ligand can be present in the aqueous solution of the cyanide-free metal salt and/or of the metal cyanide salt, or it is added directly to the suspension obtained after precipitation of the double metal cyanide compound. It has proved to be advantageous to mix the aqueous solutions of the cyanide-free metal salt and of the metal cyanide salt and the organic complexing ligand with vigorous stirring. The suspension formed in the first step is then optionally treated with a further complexing component. In this context, the complexing component is preferably employed in a mixture with water and organic complexing ligand. A preferred method for carrying out the first step (i.e. the preparation of the suspension) is carried out employing a mixing nozzle, particularly preferably employing a jet disperser as described in WO-A 01/39883.

In the second step the solid (i.e. the precursor of the catalyst according to the invention) is isolated from the suspension by known techniques, such as centrifugation or filtration.

In a preferred embodiment variant for the preparation of the catalyst, in a third process step the solid which has been isolated is subsequently washed with an aqueous solution of the organic complexing ligand (e.g. by resuspending and subsequent renewed isolation by filtration or centrifugation). In this manner, for example, water-soluble by-products, such as potassium chloride, can be removed from the catalyst. Preferably, the amount of organic complexing ligand in the aqueous wash solution is between 40 and 80 wt. %, based on the total solution.

In the third step, further complexing components are optionally added to the aqueous wash solution, preferably in the range of between 0.5 and 5 wt. %, based on the total solution.

It is moreover advantageous for the solid which has been isolated to be washed more than once. For this e.g. the first washing operation can be repeated. However, it is preferable to use non-aqueous solutions for further washing operations, e.g. a mixture of organic complexing ligand and further complexing components.

The solid which has been isolated and optionally washed is then dried, optionally after pulverization, at temperatures of in general 20-100° C. and under pressures of from in general 0.1 mbar to normal pressure (1013 mbar).

A preferred method for isolating the DMC catalysts from the suspension by filtration, washing of the filter cake and drying is described in WO-A 01/80994.

The catalyst can be employed, for example, in a content, based on the total weight of starter compound and epoxide (II) employed, of from ≧1 ppm to ≦1,000 ppm and preferably from 10 ppm to ≦500 ppm.

In the process according to the invention, it is envisaged that in step 1. the epoxide (II) contains ethylene oxide to the extent of at most 30% by weight. It has been found that at higher ethylene oxide contents no satisfactory reactions products for further processing in the subsequent steps of the process are obtained.

In the context of the present invention, it is envisaged that the crude product of the reaction from step 1. undergoes no further purification with the exception of a possible distillation step. This distillation step is consequently optional. By means of the distillation, for example, unreacted epoxide (II) can be removed from the polyol obtained. Purification steps which are precisely not used on the product would be, for example, a filtration, a solvent extraction or a chromatographic purification. Herein lies an advantage of the process according to the invention, since cost-intensive purification steps for polyether polyols prepared by the KOH process are avoided. A separate purification step is not necessary since the double metal cyanide catalysts can remain in the crude product without interfering in the subsequent reactions, and furthermore are required in only small amounts.

In step 1. (copolymerization) the metering of one or more epoxides and of the carbon dioxide can be carried out simultaneously or sequentially, it being possible for the total amount of carbon dioxide to be added all at once or by metering over the reaction time. Preferably the carbon dioxide is metered. The metering of one or more epoxides is carried out simultaneously with or sequentially to the carbon dioxide metering. If several epoxides are employed for synthesis of the polyether carbonate polyols, metering thereof can be carried out simultaneously or sequentially via in each case separate meterings, or via one or more meterings, whereby at least two epoxides are metered as a mixture. Via the nature of the metering of the epoxides and of the carbon dioxide, it is possible to synthesize random, alternating, block-like or gradient-like polyether carbonate polyols. The concentration of free epoxides during the reaction in the reaction mixture is preferably ≧0 to 40 wt. %, particularly preferably ≧0-25 wt. %, most preferably ≧0-15 wt. % (in each case based on the weight of the reaction mixture).

Preferably, an excess of carbon dioxide, based on the calculated amount of carbon dioxide incorporated in the polyether carbonate polyol, is employed, since due to the slowness of carbon dioxide to react an excess of carbon dioxide is advantageous. The amount of carbon dioxide can be determined via the overall pressure under the particular reaction conditions. The range of from 0.01 to 120 bar, preferably 0.1 to 110 bar, particularly preferably from 1 to 100 bar has proved to be advantageous as the overall pressure (absolute) for the copolymerization for the preparation of the polyether carbonate polyols. It has furthermore been found for the process according to the invention that the copolymerization for the preparation of the polyether carbonate polyols is advantageously carried out at 50 to 150° C., preferably at 60 to 145° C., particularly preferably at 70 to 140° C. and very particularly preferably at 90 to 130° C. If temperatures below 50° C. are established, the reaction ceases. At temperatures above 150° C. the amount of undesirable by-products increases greatly. It is furthermore to be ensured that under the choice of pressure and temperature CO₂ passes from the gaseous state as far as possible into the liquid and/or supercritical liquid state. However, CO₂ can also be added to the reactor as a solid and can then pass into the liquid and/or supercritical liquid state under the reaction conditions chosen.

In a further embodiment of step 1. of the process according to the invention (also called “semi-batch use” in the following), one or more starter polyols, carbon dioxide and the DMC catalyst are initially introduced into the reactor system in step 1. and one or more low molecular weight starter compounds are added continuously together with one or more alkylene oxides B1). The sum of the amounts of starter polyols and low molecular weight starter compounds employed corresponds here to the total amount of starter compounds employed in step 1. Preferably, the metering of the low molecular weight starter compounds and that of one or more alkylene oxides are ended simultaneously, or the low molecular weight starter compounds and a first part amount of one or more alkylene oxides are first metered in together and the second part amount of one or more alkylene oxides is then metered in, the sum of the first and second part amount of one or more alkylene oxides corresponding to the total amount of one or more alkylene oxides employed in step 1. The first part amount is 60 to 90 wt. % and the second part amount is 40 to 10 wt. % of the total amount of alkylene oxide employed in step 1. After these starting substances have been metered in, an after-reaction phase can follow, in which the consumption of alkylene oxide can be quantified by monitoring the pressure. When a constant pressure is reached, the end product can be drained off from the reactor (optionally after applying a vacuum or by stripping to remove unreacted alkylene oxides). The amount of starter compounds which are metered continuously into the reactor during the reaction is preferably at least 20 equivalent mol %, particularly preferably 70 to 95 equivalent mol % (in each case based on the total amount of starter compounds).

In a further embodiment of step 1. of the process according to the invention (also called “continuous use” in the following), the product resulting from step 1. is removed continuously from the reactor. In this procedure, one or more starter polyols, carbon dioxide and DMC catalyst are initially introduced into the reactor system in step 1. and one or more low molecular weight starter compounds are fed in continuously together with one or more alkylene oxides B1) and DMC catalyst and the product resulting from step 1 is removed continuously from the reactor, the pressure being kept constant, where appropriate, at the abovementioned overall pressure during the process by subsequently metering in carbon dioxide.

Particularly preferred reactors are: tube reactor, stirred tank, loop reactor. In the preparation of the polyether carbonate polyols in a stirred tank, for safety reasons the content of free epoxide (alkylene oxide) in the reaction mixture of the stirred tank should not exceed 15 wt. % (see, for example, WO-A 2004/081082; page 3; line 14). In the preparation of the polyether carbonate polyols in the semi-batch use and also in the continuous use, the metering rate of the epoxide should therefore be adjusted accordingly, so that the epoxide reacts sufficiently rapidly and the content of free epoxide in the reaction mixture of the stirred tank due to the metering in of epoxide does not exceed 15 wt. %. It is possible to feed in the carbon dioxide continuously or discontinuously. The pressure of the carbon dioxide can vary during the copolymerization. It is possible gradually to increase or to lower or to leave constant the CO₂ pressure during the addition of the epoxide. A part of the addition of the epoxide can also be carried out in the absence of CO₂, for example in order to build up a part section of the resulting copolymer from pure epoxide.

The activated catalyst-starter mixture can be (further) copolymerized with epoxide and carbon dioxide in the stirred tank, but also in another reaction container (tube reactor or loop reactor).

In the case of a tube reactor, the activated catalyst and starter and the epoxide and carbon dioxide are pumped continuously through a tube. The molar ratios of the reaction partners vary according to the desired polymer. In a preferred embodiment, carbon dioxide is metered in here in its supercritical form, that is to say virtually liquid form, in order to render possible a better miscibility of the components. Mixing elements are advantageously installed for better thorough mixing of the reaction partners, such as are marketed, for example, by Ehrfeld Mikrotechnik BTS GmbH. In fact, it is often not possible in apparatus terms to establish turbulent flow conditions with good thorough mixing, so that only a laminar flow profile is present.

Even loop reactors can be used for the preparation of polyether carbonate polyols. These are tube reactors with recycling of substances. The use of a loop reactor is of advantage in particular because back-mixing can be realized here, so that the epoxide concentration should be low. In order to realize complete conversion, a tube (“dwell tube”) is often installed downstream.

The polyether carbonate polyols obtained according to the invention have a functionality of at least 1, preferably of from 1 to 8, particularly preferably from 1 to 6 and very particularly preferably from 2 to 4. The molecular weight is preferably 400 to 10,000 g/mol and particularly preferably 500 to 6,000 g/mol.

Activation steps (in the presence or absence of carbon dioxide) for activation of the DMC catalyst employed can precede step 1. If the copolymerization is carried out in a stirred tank, the preceding step for activation of the DMC catalyst can be carried out, for example, in the stirred tank which is subsequently employed for the copolymerization, or alternatively in an upstream reactor, which itself can in turn be a tube reactor or a stirred tank. If the copolymerization is carried out in a tube reactor, the preceding step for activation of the DMC catalyst can be carried out, for example, in a first part section of the tube reactor, or in an upstream reactor, which itself can in turn be a tube reactor or a stirred tank.

A step in which a part amount of the epoxide (II), optionally in the presence of CO₂, is added to the DMC catalyst and the addition of the epoxide is then interrupted, a temperature peak (“hot spot”) and/or a drop in pressure in the reactor (if the reaction is carried out in a stirred tank) being observed due to a subsequent exothermic chemical reaction, is called an activation step for the DMC catalyst. The process step of activation is the time span from the addition of the part amount of alkylene oxide compound, optionally in the presence of CO₂, to the DMC catalyst up to the hot spot. In general, a step for drying the DMC catalyst and, if appropriate, the H-functional starter compound by elevated temperature and/or reduced pressure can precede the activation step, this step of drying not being part of the activation step in the context of the present invention.

In step 2. of the process according to the invention, the product from step 1. is reacted further. In this reaction, terminal hydroxyl groups of the polyether carbonate polyol obtained are reacted with a cyclic carboxylic acid anhydride. An ester bond to the polyether carbonate polyol and a further free carboxyl group are obtained by opening of the anhydride group. The reaction is optionally carried out in the presence of a catalyst which contains at least one nitrogen atom per molecule. Preferably, this is an organic molecule, so that the catalyst is an organic amine. However, non-cyclic tertiary amines with identical substituents are excluded. An example of such an amine which is not suitable is triethylamine. If a catalyst is employed, it is advantageously the same catalyst as in the subsequent step 3.

The amount of nitrogen-containing catalyst, based on the total weight of the reaction mixture in step 2., can be, for example, ≧10 ppm to ≦10,000 ppm, preferably ≧50 ppm to ≦5,000 ppm and more preferably ≧100 ppm to ≦2,000 ppm. In this context, the reaction temperature in step 2. can be ≧70° C. to ≦150° C. and preferably ≧80° C. to ≦135° C.

Step 3. of the process according to the invention relates to the reaction of the product obtained in step 2. with ethylene oxide. By the reaction of the carboxyl groups of the polyether carbonate, hydroxyalkyl groups are formed with ring opening. Preferably, ≧80%, ≧90% or ≧95% of the carboxyl groups react with the epoxide and a content of primary hydroxyl groups of from ≧50 mol % to ≦100 mol % or from ≧60 mol % to ≦90 mol % is preferably obtained.

It is envisaged according to the invention that this reaction is carried out in the presence of a catalyst which contains at least one nitrogen atom per molecule. Preferably, this is an organic molecule, so that the catalyst is an organic amine. However, non-cyclic tertiary amines with identical substituents are excluded according to the invention. An example of such an amine which is not suitable is triethylamine.

The amount of nitrogen-containing catalyst, based on the total weight of the reaction mixture in step 3., can be, for example, ≧10 ppm to ≦10,000 ppm, preferably ≧50 ppm to ≦5,000 ppm and more preferably ≧100 ppm to ≦2,000 ppm. In this context, the reaction temperature in step 3. can be ≧70° C. to ≦150° C. and preferably ≧80° C. to ≦135° C.

This step advantageously follows step 2. directly, so that the ethylene oxide is added to the reaction mixture from step 2. after the end of the reaction with the cyclic carboxylic acid anhydride.

In one embodiment of the process according to the invention, the starter compound employed in step 1, is a poly(oxyalkylene) polyol (i.e. a polyether polyol) or a poly(oxyalkylene) carbonate polyol (i.e. a product obtainable starting from an H-functional starter compound by copolymerization of carbon dioxide with epoxide), in each case with an average functionality of ≧2.0 to ≦5.0 and a number-average molecular weight of from ≧450 g/mol to ≦1,000 g/mol. The average functionality can also be ≧2.3 to ≦4.0. These poly(oxyalkylene) polyols and poly(oxyalkylene) carbonate polyols can also have an OH number of from 200 mg of KOH/g to ≦300 mg of KOH/g. The OH number can be determined with the aid of the standard DIN 53240.

In a further embodiment of the process according to the invention, in the epoxide of the general formula (II) R1 is hydrogen, methyl, ethyl, n-propyl, iso-propyl, n-butyl, sec-butyl, iso-butyl, tert-butyl, cyclohexyl and/or phenyl. Preferably, R1 is methyl here. The epoxide employed is then propylene oxide. Mixtures of propylene oxide and ethylene oxide are likewise preferred, so that mixed polyether blocks are obtained. Several mixtures of propylene oxide and ethylene oxide with different mixture ratios can also be employed in succession.

In a further embodiment of the process according to the invention, the double metal cyanide catalyst in step 1. comprises zinc, cobalt and tert-butanol. Preferably, this catalyst additionally comprises ≧5% by weight to ≦80% by weight, based on the amount of catalyst, of a polyether with a number-average molecular weight of ≧500 g/mol. The content of polyether can also be 2.10% by weight to ≦70% by weight and particularly preferably ≧15% by weight to ≦% by weight. Particularly suitable polyethers are, for example, polyether polyols with an average OH functionality of from 2 to 8 and a number-average molecular weight of from ≧1,000 g/mol to 10,000 g/mol and preferably from ≧1,000 g/mol to ≦5,000 g/mol. Poly(oxypropylene) polyols, in particular diols and/or triols with a number-average molecular weight of from ≧1,000 g/mol to ≦4,000 g/mol may be mentioned as an example.

In a further embodiment of the process according to the invention, the cyclic carboxylic acid anhydride employed in step 2. is chosen from the group comprising phthalic anhydride, tetrahydrophthalic anhydride, succinic anhydride and/or maleic anhydride.

In a further embodiment of the process according to the invention, the catalyst employed in step 3. is chosen from the group comprising:

(A) amines of the general formula (IX):

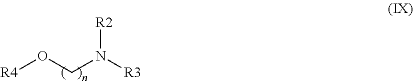

wherein:
R2 and R3 independently of each other are hydrogen, alkyl or aryl; or
R2 and R3 together with the N atom carrying them form an aliphatic, unsaturated or aromatic heterocycle;
n is an integer from 1 to 10;
R4 is hydrogen, alkyl or aryl; or
R4 represents —(CH₂)ₓ—N(R41)(R42), wherein:
   R41 and R42 independently of each other are hydrogen, alkyl or aryl; or
   R41 and R42 together with the N atom carrying them form an aliphatic, unsaturated or aromatic heterocycle;
   x is an integer from 1 to 10;
      (B) amines of the general formula (X):

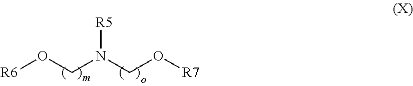

wherein:
R5 is hydrogen, alkyl or aryl;
R6 and R7 independently of each other are hydrogen, alkyl or aryl;
m and o independently of each other are an integer from 1 to 10;
   and/or:
   (C) diazabicyclo[2.2.2]octane, diazabicyclo[5.4.0]undec-7-ene, dialkylbenzylamine, dimethylpiperazine, 2,2′-dimorpholinyldiethyl ether and/or pyridine.

The catalyst which can optionally be employed in step 2. of the process can likewise be chosen from the groups (A), (B) and/or (C) described.

Amines of the general formula (IX) can be described in the broadest sense as amino alcohols or ethers thereof. If R4 is hydrogen, the catalysts can be incorporated into a polyurethane matrix when the polyether carbonate polyol is reacted with a polyisocyanate. This is advantageous in order to prevent emergence of the catalyst, which in the case of amines may be accompanied by an adverse odour problem, on the polyurethane surface, so-called “fogging” or VOC (volatile organic compounds) problems.

Amines of the general formula (X) can be described in the broadest sense as amino (bis)alcohols or ethers thereof. If R6 or R7 are hydrogen, these catalysts can likewise be incorporated into a polyurethane matrix.

It is preferable, in the amine of the general formula (IX), for R2 and R3 to be methyl, R4 to be hydrogen and n to be 2, or R2 and R3 to be methyl, R4 to be —(CH₂)₂-M(CH₃)₂ and n to be 2. Overall, either N,N-dimethylethanolamine or bis(2-(dimethylamino)ethyl)ether results.

It is furthermore preferable, in the amine of the general formula (X), for R5 to be methyl, R6 and R7 to be hydrogen, m to be 2 and o to be 2. Overall, N-methyldiethanolamine thus results.

In a further embodiment of the process according to the invention, in step 2. the molar ratio of cyclic anhydride to hydroxyl groups in the product obtained in step 1. is ≧0.75:1 to ≦1.3:1. Preferably, the ratio is ≧0.95:1 to ≦1.25:1, more preferably ≧1.02:1 to ≦1.15:1.

In a further preferred embodiment of the process according to the invention, in step 3. the catalyst, which contains at least one nitrogen atom per molecule, is present in a content of from ≧500 ppm to ≦1,500 ppm, based on the total weight of the reaction mixture. The content of the catalyst can also be ≧750 ppm to ≦1,250 ppm. The same applies accordingly if such a catalyst is also employed in step 2.

In a further embodiment of the process according to the invention, in step 3. the molar ratio of ethylene oxide to hydroxyl groups in the product obtained in step 1. is ≧0.90:1 to ≦5.0:1. The ratio can also be ≧1.0:1 to ≦2.0:1 or preferably ≧1.05:1 to ≦1.2:1.

The present invention furthermore provides a polyether carbonate polyol with primary hydroxyl end groups, obtainable by a process according to the invention and comprising a polyether carbonate block, a terminal hydroxyethyl group and a diester unit which joins the polyether carbonate block and the terminal hydroxyethyl group, and wherein the molar content of terminal double bonds, based on all the end groups of the polyether carbonate polyol, is ≧0 milliequivalent per kg to ≦10 milliequivalents per kg. The polyether carbonate polyol is obtainable by a process according to the invention and is obtained, in particular, by this process. For details of its build-up, reference is therefore made to the statements on the process.

The polyether carbonate block can be, for example, without being limited thereto, a block, started on a di-, tri-, tetra- or pentafunctional alcohol, of carbon dioxide with ethylene oxide, propylene oxide, or ethylene oxide/propylene oxide and/or any desired sequence of these blocks. The number of monomer units in the polyether carbonate block can be in a range of from ≧10 monomer units to ≦5,000 monomer units, preferably from ≧50 monomer units to ≦1,000 monomer units.

The polyether carbonate block is followed by a diester unit, which can be attributed to the product of the reaction of an OH end group of the polyether carbonate block with a cyclic carboxylic acid anhydride. A half ester is first formed by ring opening, and then reacts with ethylene oxide to give the hydroxyethyl end group. Examples of the cyclic carboxylic acid anhydride are phthalic anhydride, tetrahydrophthalic anhydride, succinic anhydride and/or maleic anhydride.

The polyether carbonate polyol according to the invention is distinguished in that the content of terminal double bonds, based on all the end groups of the polyether carbonate polyol (by which is to be understood here the entirety of the polyether carbonate polyol molecules), in the range of from ≧0 to ≦10 milliequivalents per kg, regardless of the molecular weight. For all practical purposes, it is thus free from unsaturated end groups. These end groups would lead to a reduced functionality of the polyether carbonate and would cause corresponding disadvantages in the preparation of polyurethane polymers. The terminal double bonds are avoided, for example, by polymerizing the polyether carbonate block on to the starter alcohol by means of DMC catalysis. The polyether carbonate polyol according to the invention can be analysed for the absence of unsaturated end groups by means of ¹H-NMR spectroscopy. A further customary method is determination of the terminal double bonds by means of mercury acetate in accordance with ISO 17710. The content can also be ≧0 milliequivalents per kg to ≦5 milliequivalents per kg. Polyether carbonate polyols according to the invention can furthermore have functionalities in the range of from ≧2 to ≦6 and molecular weights in the range of from ≧1,800 Da to ≦20,000 Da.

In one embodiment of the polyether carbonate polyol according to the invention, the molar content of primary hydroxyl groups is ≧50 mol % to ≦100 mol %. This is to be understood as meaning the molar content of primary hydroxyl groups compared with secondary hydroxyl groups in the polyether carbonate polyol in total, that is to say not based on an individual molecule. It can be determined, for example, by means of ¹H-NMR spectroscopy. The content can also be in a range of from ≧55 mmol % to ≦90 mol % or from ≧60 mol % to ≦85 mol %.

In a further embodiment of the polyether carbonate polyol according to the invention, this has an OH number of from ≧10 mg of KOH/g to ≦100 mg of KOH/g. The hydroxyl number can be determined with the aid of the standard DIN 53240 and can also be ≧15 mg of KOH/g to ≦80 mg of KOH/g or ≧20 mg of KOH/g to ≦50 mg of KOH/g.

In a further embodiment of the polyether carbonate polyol according to the invention, this has an acid number of from ≧0.01 mg of KOH/g to ≦5 mg of KOH/g. The acid number can be determined with the aid of the standard DIN 53402 and can also be ≧0.02 mg of KOH/g to ≦4.9 mg of KOH/g or ≧0.02 mg of KOH/g to ≦4.8 mg of KOH/g.

The present invention also provides a polyether carbonate polyol composition comprising a polyether carbonate polyol according to the invention and furthermore:

(A) amines of the general formula (XI):

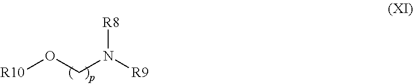

wherein:
R8 and R9 independently of each other are hydrogen, alkyl or aryl; or
R8 and R9 together with the N atom carrying them form an aliphatic, unsaturated or aromatic heterocycle;
p is an integer from 1 to 10, that is to say 1, 2, 3, 4, 5, 6, 7, 8, 9 or 10;
R10 is hydrogen, alkyl or aryl; or
R10 represents —(CH₂)_{y}—N(R11)(R12), wherein:
   R11 and R12 independently of each other are hydrogen, alkyl or aryl; or
   R11 and R12 together with the N atom carrying them form an aliphatic, unsaturated or aromatic heterocycle;
   y is an integer from 1 to 10, that is to say 1, 2, 3, 4, 5, 6, 7, 8, 9 or 10;
      (B) amines of the general formula (XII):

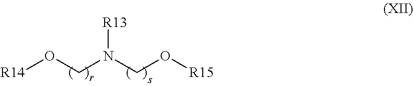

wherein:
R13 is hydrogen, alkyl or aryl;
R14 and R15 independently of each other are hydrogen, alkyl or aryl;
r and s independently of each other are an integer from 1 to 10, that is to say 1, 2, 3, 4, 5, 6, 7, 8, 9 or 10;
   and/or:
   (C) diazabicyclo[2.2.2]octane, diazabicyclo[5.4.0]undec-7-ene, dialkylbenzylamine, dimethylpiperazine, 2,2′-dimorpholinyldiethyl ether and/or pyridine.

In certain variants, such compounds can also be used as so-called blowing agent catalysts, that is to say they preferentially catalyse the reaction of the isocyanate groups with water to form carbon dioxide, and to a lesser extent also reaction thereof with hydroxyl groups to form urethane groups. This composition can therefore be directly employed further in the preparation of polyurethanes. If Zerewitinoff-active hydrogen atoms are present, these catalysts can be incorporated into a polyurethane matrix. This reduces the content of volatile organic substances in the polyurethane. N,N-Dimethylethanolamine, bis(2-(dimethylamino)ethyl)ether, N-methyldiethanolamine or diazabicyclo[2.2.2]octane are preferred.

The weight content of these compounds (A), (B) and/or (C), relative to the polyether carbonate polyol according to the invention, can be, for example, ≧10 ppm to ≦10,000 ppm, preferably 50 ppm to ≦5,000 ppm and more preferably ≧100 ppm to ≦2,000 ppm.

The present invention also provides a polyurethane polymer obtainable from the reaction of a polyisocyanate with a polyether carbonate polyol according to the invention or a polyether carbonate polyol composition according to the invention. The term “polyurethane polymer” also includes, according to the invention, prepolymers which are obtainable from the reaction of a polyisocyanate with a polyether carbonate polyol according to the invention or a polyether carbonate polyol composition according to the invention.

The polyether carbonate polyols according to the invention are suitable, for example, for the production of polyurethane flexible foams, preferably of polyurethane flexible foams with a bulk density according to DIN EN ISO 3386-1-98 in the range of from ≧10 kg/m³ to ≦150 kg/m³, preferably of from ≧20 kg/m³ to ≦70 kg/m³, and a compressive strength according to DIN EN ISO 3386-1-98 in the range of from ≧0.5 kPa to ≦20 kPa (at 40% deformation and the 4th cycle). For production of the polyurethane flexible foams, the reaction components are reacted by the one-stage process which is known per se, mechanical equipment often being used, e.g. that described in EP-A 355 000. Details of processing equipment which is also possible according to the invention are described in Kunststoff-Handbuch, volume VII, published by Vieweg and Höchtlen, Carl-Hanser-Verlag, Munich 1993, e.g. on pages 139 to 265. The polyurethane flexible foams can be produced as moulded foams or also as block foams. The invention therefore provides a process for the production of polyurethane flexible foams, the polyurethane flexible foams produced by this process, the polyurethane flexible block foams and polyurethane flexible moulded foams produced by this process, the use of the polyurethane flexible foams for the production of moulding and the mouldings themselves. The polyurethane flexible foams obtainable according to the invention have, for example, the following use: furniture padding, textile inserts, mattresses, automobile seats, head rests, arm rests, foams and structural elements.

The characteristic number (index) indicates the percentage ratio of the amount of isocyanate actually employed to the stoichiometric (NCO) amount, i.e. the amount of isocyanate groups calculated for the reaction of the OH equivalents.

Characteristic number=[(isocyanate amount employed)(calculated isocyanate amount)]·100 (XIII)

Polyurethane flexible foams in the context of the present invention are preferably those polyurethane polymers of which the bulk density according to DIN EN ISO 3386-1-98 is in the range of from ≧10 kg/m³ to ≦150 kg/m³, preferably in the range of from ≧20 kg/m′ to ≦70 kg/m³, and of which the compressive strength according to DIN EN ISO 3386-1-98 is in the range of from ≧0.5 kPa to ≦20 kPa (at 40% deformation and the 4th cycle).

The present invention is explained further with the aid of the following examples.

### EXAMPLES

The materials and abbreviations used have the following meaning and sources of supply:
2,2,2-Diazabicyclooctane: Aldrich.
Tetrahydrophthalic anhydride (THPA): Aldrich.
Tegostab® B 8681: formulation of organo-modified polysiloxanes, Evonik Goldschmidt.
Tegostab® B 8715LF: formulation of organo-modified polysiloxanes, Evonik Goldschmidt
PET 1: polyether polyol with an OH number of approx. 28 mg of KOH/g, prepared by means of KOH-catalysed addition of propylene oxide and ethylene oxide in the weight ratio of 85 to 15 using a mixture of glycerol and sorbitol as starter compounds, with approx. 85 mol % of primary OH groups and containing 8.6 wt. % of filler (copolymer essentially of styrene and acrylonitrile).
PET 2: polyether polyol with an OH number of approx. 28 mg of KOH/g, prepared by means of KOH-catalysed addition of propylene oxide and ethylene oxide in the weight ratio of 85 to 15 using glycerol as the starter compound, with approx. 85 mol % of primary OH groups.
PET 3: polyether polyol with an OH number of 37 mg of KOH/g, prepared by means of KOH-catalysed addition of propylene oxide and ethylene oxide in the weight ratio of 27 to 73 using glycerol as the starter compound.
Amine 1: amine catalyst (2,2,2-diazabicyclooctane, 33 wt. % strength in dipropylene glycol).
Amine 2: amine catalyst (bis(dimethylaminoethyl)ether, 70 wt. % strength in dipropylene glycol).
Amine 3: N,N-bis(3-dimethylaminopropyl)-N-isopropanolamine.
Amine 4: amine catalyst Dabco® NE 300, Air Products, Hamburg, Germany.
Urea solution (50% strength H₂O): solution of urea in water (50 wt. % strength).
Sn cat: tin(II) octoate
MDI 1: mixture containing 57 wt. % of 4,4′-diphenylmethane-diisocyanate, 25 wt. % of 2,4′-diphenylmethane-diisocyanate and 18 wt. % of polyphenylpolymethylene-polyisocyanate (“polynuclear MDI”) with an NCO content of 32.5% by weight.
TDI 1: mixture of 80 wt. % of 2,4-toluoylene-diisocyanate and 20 wt. % of 2,6-toluoylene-diisocyanate.

The analyses were carried out as follows:
Dynamic viscosity: MCR 51 rheometer from Anton Paar in accordance with DIN 53019 with a CP 50-1 measuring cone (diameter 50 mm, angle 1°) at shear rates of 25, 100, 200 and 500 s⁻¹. The polyether carbonate polyols according to the invention show viscosities which are independent of the shear rate.

Determination of the molar content of primary OH groups: by means of ¹H-NMR (Bruker DPX 400, deuterochloroform)
Hydroxyl number: with the aid of the standard DIN 53240
Acid number: with the aid of the standard DIN 53402

The ratio of the primary and secondary OH groups was determined by means of ¹H-NMR (Bruker DPX 400, deuterochloroform).

The content of incorporated CO₂ in the resulting polyether carbonate polyol and the ratio of propylene carbonate to polyether carbonate polyol were determined by means of ¹H-NMR (Bruker, DPX 400, 400 MHz; pulse program zg30, waiting time dl: 10 s, 64 scans). The sample was dissolved in deuterated chloroform in each case. The relevant resonances in the ¹H-NMR (based on TMS=0 ppm) are as follows:

Cyclic carbonate (which was formed as a by-product) with resonance at 4.5 ppm, carbonate, resulting from carbon dioxide incorporated in the polyether carbonate polyol, with resonances at 5.1 to 4.8 ppm, unreacted PO with resonance at 2.4 ppm, polyether polyol (i.e. without incorporated carbon dioxide) with resonances at 1.2 to 1.0 ppm, the 1,8-octanediol incorporated as the starter molecule (if present) with a resonance at 1.6 to 1.52 ppm.

The molar content of the carbonate incorporated in the polymer in the reaction mixture is calculated according to formula (XIV) as follows, the following abbreviations being used:
A(4.5)=area of the resonance at 4.5 ppm for cyclic carbonate (corresponds to an H atom)
A(5.1-4.8)=area of the resonance at 5.1-4.8 ppm for polyether carbonate polyol and an H atom for cyclic carbonate.
A(2.4)=area of the resonance at 2.4 ppm for free, unreacted PO
A(1.2-1.0)=area of the resonance at 1.2-1.0 ppm for polyether polyol
A(1.6-1.52)=area of the resonance at 1.6 to 1.52 ppm for 1,8-octanediol (starter), if present

Taking into account the relative intensities, the polymer-bonded carbonate (“linear carbonate” LC) in the reaction mixture was converted into mol % according to the following formula (XIV)

$$L C = \frac{A ( 5.1 - 4.8 ) - A ( 4.5 )}{\begin{matrix}A ( 5.1 - 4.8 ) + A ( 2.4 ) + 0.33 * \\ A ( 1.2 - 1.0 ) + 0.25 * A ( 1.6 - 1.52 )\end{matrix}} * 100 \qquad ( XIV )$$

The weight content (in wt. %) of polymer-bonded carbonate (LC′) in the reaction mixture was calculated according to formula (XV)

$$L {C}^{′} = \frac{[ A ( 5.1 - 4.8 ) - A ( 4.5 ) ] * 102}{N} * 100 \% \qquad ( XV )$$

the value for N (“denominator” N) being calculated according to formula (XVI):

N=[A(5.1−4.8)−A(4.5)]*102+A(4.5)*102+A(2.4)*58+0.33*A(1.2−1.0)*58+0.25*A(1.6−1.52)*146 (XVI)

The factor 102 results from the sum of the molecular weights of CO₂ (molecular weight 44 g/mol) and that of propylene oxide (molecular weight 58 g/mol), the factor 58 results from the molecular weight of propylene oxide and the factor 146 results from the molecular weight of the starter employed, 1,8-octanediol (if present).

The weight content (in wt. %) of cyclic carbonate (CC') in the reaction mixture was calculated according to formula (XVII)

$$C {C}^{′} = \frac{A ( 4.5 ) * 102}{N} * 100 \% \qquad ( XVII )$$

the value for N being calculated according to formula (XVI).

In order to calculate from the values of the composition of the reaction mixture the composition based on the polymer content (consisting of polyether polyol, which was built up from the starter and propylene oxide during the activation steps which took place under CO₂-free conditions, and polyether carbonate polyol, built up from the starter, propylene oxide and carbon dioxide during the activation steps which took place in the presence of CO₂ and during the copolymerization), the non-polymer constituents of the reaction mixture (i.e. cyclic propylene carbonate and any unreacted propylene oxide present) were eliminated by calculation. The weight content of the carbonate recurring units in the polyether carbonate polyol was converted into a weight content of carbon dioxide by means of the factor F=44/(44+58). The CO₂ content in the polyether carbonate polyol stated is standardized to the content of the polyether carbonate polyol molecule which was formed during the copolymerization and, where appropriate, the activation steps in the presence of CO₂ (i.e. the content of the polyether carbonate polyol molecule which results from the starter (1,8-octanediol, if present) and from the reaction of the starter with epoxide which was added under CO₂-free conditions was not taken into account here).

The bulk density was determined in accordance with DIN EN ISO 3386-1-98.

The compressive strength was determined in accordance with DIN EN ISO 3386-1-98 (at 40% deformation and the 4th cycle).

The tensile strength and elongation at break were determined in accordance with DIN EN ISO 1798.

The compression set CS 50% (Ct) and CS 75% (Ct) were determined in accordance with DIN EN ISO 1856-2001-03 at 50% and 75% deformation.

### 1. Preparation of the DMC-Catalysed Precursors:

### Precursor A:

141 mg of dried DMC catalyst (prepared in accordance with Example 6 of WO-A 01/80994) and 51 g of dried 1,8-octanediol (starter) were initially introduced into a 1 litre pressure reactor with a gas metering device. The reactor was heated up to 130° C. and rendered inert by repeated charging with nitrogen to approx. 5 bar and subsequent letting down to approx. 1 bar. This operation was carried out 3 times. 25 g of propylene oxide (PO) were metered rapidly into the reactor at 130° C. and in the absence of CO₂. The start-up of the reaction manifested itself by a temperature peak (“hot spot”) and by a drop in pressure to about the starting pressure (approx. 1 bar). After the first drop in pressure, 20 g of PO and then 19 g of PO were metered in rapidly, as a result of which in each case a temperature peak and a drop in pressure in turn occurred. After the reactor had been charged with 50 bar of CO₂, 50 g of PO were metered in rapidly, as a result of which a temperature peak occurred after a further waiting time. At the same time, the pressure of carbon dioxide CO₂ started to fall. The pressure was regulated such that when it dropped below the set value, fresh CO₂ was added. Only then was the remaining propylene oxide (435 g) pumped continuously into the reactor at approx. 1.8 g/min, while after 10 minutes the temperature was lowered to 105° C. in steps of 5° C. per five minutes. When the addition of PO had ended, stirring was continued (1,500 rpm) for a further 60 minutes at 105° C. under the abovementioned pressure. Finally, readily volatile constituents were separated off from the product by thin film evaporation.

The OH number of precursor A was 65.0 mg of KOH/g at a viscosity (25° C.) of 1,375 mPas. The CO₂ content in the product was about 14 wt. %.

### Precursor B:

134 mg of dried DMC catalyst (prepared in accordance with Example 6 of WO-A 01/80994) and 160 g of a dried trifunctional poly(oxypropylene) polyol with an OH number=235 mg of KOH/g, as the starter, were initially introduced into a 1 litre pressure reactor with a gas metering device. The reactor was heated up to 130° C. and rendered inert by repeated charging with nitrogen to approx. 5 bar and subsequent letting down to approx. 1 bar. This operation was carried out 3 times. 24 g of propylene oxide (PO) were metered rapidly into the reactor at 130° C. and in the absence of CO₂. The start-up of the reaction manifested itself by a temperature peak (“hot spot”) and by a drop in pressure to about the starting pressure (approx. 1 bar). After the first drop in pressure, 20 g of PO and then 18 g of PO were metered in rapidly, as a result of which in each case a temperature peak and a drop in pressure in turn occurred. After the reactor had been charged with 50 bar of CO₂, 48 g of PO were metered in rapidly, as a result of which a temperature peak occurred after a further waiting time. At the same time, the pressure of carbon dioxide CO₂ started to fall. The pressure was regulated such that when it dropped below the set value, fresh CO₂ was added. Only then was the remaining propylene oxide (508 g) pumped continuously into the reactor at approx. 1.8 g/min, while after 10 minutes the temperature was lowered to 105° C. in steps of 5° C. per five minutes. When the addition of PO had ended, stirring. was continued (1,500 rpm) for a further 60 minutes at 105° C. under the abovementioned pressure. Finally, readily volatile constituents were separated off from the product by thin film evaporation. The OH number of precursor B was 47.1 mg of KOH/g at a viscosity (25° C.) of 8,820 mPas. The CO₂ content in the product was 15 wt. %.

2. Reaction of the DMC-Catalysed Precursors with Cyclic Anhydrides and Ethylene Oxide Under Amine Catalysis:

### Example 1

400 g of the DMC-catalysed precursor A, 74.04 g of tetrahydrophthalic anhydride and 0.474 g (920 ppm, based on the total mixture) of 2,2,2-diazabicyclooctane were initially introduced into a 1 litre high-grade steel pressure reactor under nitrogen. The molar ratio between anhydride and the hydroxyl groups of precursor A was 1.05/1. The mixture was then heated up to 125° C. and stirred at this temperature for 60 minutes. 40.84 g of ethylene oxide were then metered into the reactor at 125° C. over a period of 60 minutes. The molar ratio between ethylene oxide and the hydroxyl groups of precursor A was 2/1. After an after-reaction time at 125° C. until the pressure in the reactor was constant (3 h), readily volatile contents were distilled off in vacuo at 90° C. for 30 minutes and the reaction mixture was then cooled to room temperature.

### Product Properties:

OH number: 53.6 mg of KOH/g
Acid number: 0.08 mg of KOH/g
Viscosity (25° C.): 6,415 mPas
Primary OH groups: 83%

### Example 2

500 g of the DMC-catalysed precursor B, 67.1 g of tetrahydrophthalic anhydride and 0.60 g (1,000 ppm, based on the total batch) of 2,2,2-diazabicyclooctane were initially introduced into a 1 litre high-grade steel pressure reactor under nitrogen. The molar ratio between anhydride and the hydroxyl groups of precursor B was 1.05/1. The mixture was then heated up to 125° C. and stirred at this temperature for 60 minutes. 37 g of ethylene oxide were then metered into the reactor at 125° C. over a period of 60 minutes. The molar ratio between ethylene oxide and the hydroxyl groups of precursor B was 2/1. After an after-reaction time at 125° C. until the pressure in the reactor was constant (3 h), readily volatile contents were distilled off in vacuo at 90° C. for 30 minutes and the reaction mixture was then cooled to room temperature.

### Product Properties:

OH number: 42.8 mg of KOH/g
Acid number: 1.06 mg of KOH/g
Viscosity (25° C.): 28,350 mPas
Primary OH groups: 82%

### 3. Production of Polyurethane Flexible Block Foams

The starting substances listed in the examples of the following Table 1 are reacted with one another in the conventional method of processing for the production of polyurethane foams by the one-stage process.

TABLE 1
Production and evaluation of the polyurethane flexible block foams

| | | 3 | |
|---|---|---|---|
| | | (comp.) | 4 |
| Component A | | | |
| PET 1 | [pt. by wt.] | 96.58 | 77.26 |
| Polyol from Example 2 | [pt. by wt.] | | 19.32 |
| Water (added) | [pt. by wt.] | 2.01 | 2.01 |
| Tegostab ® B 8681 | [pt. by wt.] | 0.39 | 0.39 |
| Amine 1 | [pt. by wt.] | 0.16 | 0.16 |
| Amine 2 | [pt. by wt.] | 0.05 | 0.05 |
| Urea solution (50% strength H₂O) | [pt. by wt.] | 0.39 | 0.39 |
| Diethanolamine | [pt. by wt.] | 0.26 | 0.26 |
| Sn cat | [pt. by wt.] | 0.16 | 0.16 |
| Component B: | | | |
| TDI 1 | [WR] | 28.01 | 28.49 |
| Characteristic number | | 110 | 110 |
| Result: | | | |
| Starting time | [s] | 11 | 11 |
| Rising time | [s] | 90 | 95 |
| Foam evaluation | | fine | fine |
| Cell structure | | good | good |
| Bulk density | [kg/m³] | 44.7 | 48.1 |
| Tensile strength | [kPa] | 94 | 94 |
| Elongation at break | [%] | 106 | 104 |
| Compressive strength | [kPa] | 4.84 | 5.06 |

Abbreviations:
comp. = comparison examples;
pt. by wt. = parts by weight;
WR = weight ratio of component A to component B at the stated characteristic number and based on 100 parts by weight of component A.

The polyurethane flexible block foams obtained were subjected to a visual evaluation. The polyurethane flexible block foams were classified (“foam evaluation”) with the aid of a scale of coarse-medium-fine. A classification of “coarse” here means that the foam has fewer than approx. 5 cells per cm. A classification of “medium” means that the foam has more than approx. 5 cells per cm and fewer than approx. 12 cells per cm, and a classification of “fine” means that the foam has more than approx. 12 cells per cm.

The foam quality of the polyurethane flexible block foams was classified with respect to the cell structure with the aid of a scale of poor-moderate-good. A classification of “poor” here means that the foam has no uniform cell structure and/or visible defects. A classification of “moderate” means that the foam has a chiefly uniform cell structure with only few visible defects, and a classification of “good” means that the foam has a uniform cell structure without visible defects.

The polyurethane flexible block foam according to the invention (Example 4), in which the polyol from Example 2 was processed, could be produced like the flexible foam based on pure polyol PET 1 with a recipe which was otherwise unchanged (Comparison Example 3), i.e. there were no substantial differences from Comparison Example 3 with respect to processing, compressive strength and tensile properties.

### 4. Production of Polyurethane Flexible Moulded Foams

The starting substances listed in the examples of the following Table 2 are reacted with one another in the conventional method of processing for the production of polyurethane flexible moulded foams by the one-stage process. The reaction mixture is introduced into a metal mould of 9.7 l volume heated to 60° C., and released from the mould after 5 min. The amount of raw materials employed was chosen such that a calculated moulding density of about 57 kg/m³ results. The moulding density actually obtained, which was determined in accordance with DIN EN ISO 3386-1-98, is stated in Table 2.

TABLE 2
Production and evaluation of the polyurethane flexible moulded foams

| | | 5 | 6 | 7 |
|---|---|---|---|---|
| Component A | | | | |
| PET 1 | [pt. by wt.] | 75.61 | 75.61 | 56.10 |
| PET 2 | [pt. by wt.] | 2.44 | 2.44 | 2.44 |
| Polyol from Example 2 | [pt. by wt.] | 19.51 | 19.51 | 39.02 |
| Diethanolamine | [pt. by wt.] | 0.98 | 0.98 | 0.98 |
| Tegostab B 8715 LF | [pt. by wt.] | 0.98 | 0.98 | 0.98 |
| Amine 3 | [pt. by wt.] | 0.39 | 0.39 | 0.39 |
| Amine 4 | [pt. by wt.] | 0.10 | 0.10 | 0.10 |
| Component B: | | | | |
| MDI 1 | [WR] | 48.46 | 53.85 | 54.54 |
| Characteristic number | | 90 | 100 | 100 |
| Result | | | | |
| Bulk density | [kg/m³] | 56.5 | 56.7 | 58.3 |
| Compressive strength | [kPa] | 6.55 | 9.29 | 10.99 |
| Tensile strength | [kPa] | 134 | 167 | 175 |
| Elongation at break | [%] | 104 | 96 | 83 |
| CS 50%/22 h/70° C. | [%] | 7.2 | 7.0 | 7.2 |
| CS 75%/22 h/70° C. | [%] | 9.2 | 8.3 | 9.2 |

Abbreviations:
pt. by wt. = parts by weight;
WR = weight ratio of component A to component B at the stated characteristic number and based on 100 parts by weight of component A.

The polyether carbonate polyols according to the invention could be processed to polyurethane flexible moulded foams without problems (Example 5 to 7), the polyurethane flexible moulded foams have a good level of properties.

1-15. (canceled)

16. A process for preparing a polyether carbonate polyol with a primary hydroxyl end group, comprising:
1) reacting a starter compound comprising an active hydrogen atom with carbon dioxide and with an epoxide of formula (II): 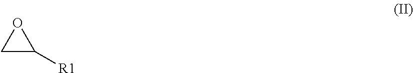
wherein
R1 is hydrogen, an alkyl radical or an aryl radical, with the proviso that ≧0% by weight to ≦30% by weight, based on the total amount of the epoxide (II) employed, is ethylene oxide, and
wherein the reaction is carried out in the presence of a double metal cyanide catalyst;
2) reacting the reaction product obtained in step 1) with a cyclic carboxylic acid anhydride; and
3) reacting the reaction product obtained in step 2) with ethylene oxide in the presence of a catalyst which comprises at least one nitrogen atom per molecule, excluding a non-cyclic tertiary amine with identical substituents.

17. The process of claim 16, wherein the starter compound in step 1) is a poly(oxyalkylene) polyol or a poly(oxyalkylene) carbonate polyol which has a number of hydroxyl groups per molecule of from ≧2.0 to ≦5.0 and a number-average molecular weight of from ≧450 g/mol to ≦2,000 g/mol.

18. The process of claim 16, wherein in R1 is hydrogen, methyl, ethyl, n-propyl, iso-propyl, n-butyl, sec-butyl, iso-butyl, tert-butyl, cyclohexyl or phenyl.

19. The process of claim 16, wherein the cyclic carboxylic acid anhydride in step 2) comprises phthalic anhydride, tetrahydrophthalic anhydride, succinic anhydride, and/or maleic anhydride.

20. The process of claim 16, wherein the catalyst in step 3) comprises
(A) an amine of formula (IX): 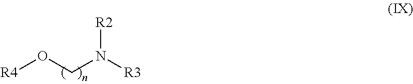
wherein:
R2 and R3 independently of each other are hydrogen, alkyl or aryl; or
R2 and R3 together with the N atom carrying them form an aliphatic, unsaturated or aromatic heterocycle;
n is an integer from 1 to 10;
R4 is hydrogen, alkyl or aryl; or
R4 is —(CH₂)ₓ—N(R41)(R42), wherein:
R41 and R42 independently of each other are hydrogen, alkyl or aryl; or
R41 and R42 together with the N atom carrying them form an aliphatic, unsaturated or aromatic heterocycle;
x is an integer from 1 to 10;
(B) an amine of formula (X): 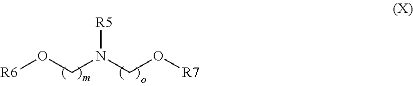
wherein:
R5 is hydrogen, alkyl or aryl;
R6 and R7 independently of each other are hydrogen, alkyl or aryl;
m and o independently of each other are an integer from 1 to 10;
and/or
(C) diazabicyclo[2.2.2]octane, diazabicyclo[5.4.0]undec-7-ene, dialkylbenzylamine, dimethylpiperazine, 2,2′-dimorpholinyldiethyl ether and/or pyridine.

21. The process of claim 16, wherein in step 2) the molar ratio of cyclic anhydride to hydroxyl groups in the product obtained in step 1) is ≧0.75:1 to ≦1.3:1.

22. The process of claim 16, wherein in step 3) the catalyst, which comprises at least one nitrogen atom per molecule, is present in an amount of from ≧500 ppm to ≦1,500 ppm, based on the total weight of the reaction mixture in steps 2) and 3)

23. The process of claim 16, wherein in step 3) the molar ratio of ethylene oxide to hydroxyl groups in the product obtained in step 1) is ≧0.90:1 to ≦5.0:1.

24. A polyether carbonate polyol with primary hydroxyl end groups, obtained by the process of claim 16, comprising a polyether carbonate block, a terminal hydroxyethyl group and a diester unit which joins the polyether carbonate block and the terminal hydroxyethyl group, and wherein the molar content of terminal double bonds, based on all the end groups of the polyether carbonate polyol, is ≧0 milliequivalent per kg to ≦10 milliequivalents per kg.

25. The polyether carbonate polyol with primary hydroxyl end groups of claim 24, wherein the molar content of primary hydroxyl groups is ≧50 mol % to ≦100 mol %.

26. The polyether carbonate polyol with primary hydroxyl end groups of claim 24, with an OH number of from ≧10 mg of KOH/g to ≦100 mg of KOH/g.

27. The polyether carbonate polyol with primary hydroxyl end groups of claim 24, with an acid number of from ≧0.01 mg of KOH/g to ≦5 mg of KOH/g.

28. A polyether carbonate polyol composition, comprising
the polyether carbonate polyol of claim 25 and:
(A) an amine of formula (XI): 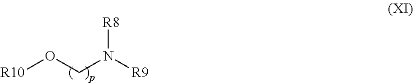
wherein:
R8 and R9 independently of each other are hydrogen, alkyl or aryl; or
R8 and R9 together with the N atom carrying them form an aliphatic, unsaturated or aromatic heterocycle;
p is an integer from 1 to 10, that is to say 1, 2, 3, 4, 5, 6, 7, 8, 9 or 10;
R10 is hydrogen, alkyl or aryl; or
R10 represents —(CH₂)_{y}—N(R11)(R12), wherein:
R11 and R12 independently of each other are hydrogen, alkyl or aryl; or
R11 and R12 together with the N atom carrying them form an aliphatic, unsaturated or aromatic heterocycle;
y is an integer from 1 to 10, that is to say 1, 2, 3, 4, 5, 6, 7, 8, 9 or 10;
(B) an amine of formula (XII): 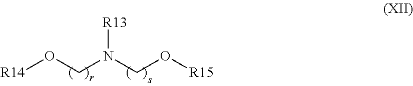
wherein:
R13 is hydrogen, alkyl or aryl;
R14 and R15 independently of each other are hydrogen, alkyl or aryl;
r and s independently of each other are an integer from 1 to 10, that is to say 1, 2, 3, 4, 5, 6, 7, 8, 9 or 10;
and/or:
(C) diazabicyclo[2.2.2]octane, diazabicyclo[5.4.0]undec-7-ene, dialkylbenzylamine, dimethylpiperazine, 2,2′-dimorpholinyldiethyl ether and/or pyridine.

29. A polyurethane polymer obtained from the reaction of a polyisocyanate with the polyether carbonate polyol of claim 24 or the polyether carbonate polyol composition of claim 28.

30. The polyurethane polymer of claim 29, wherein the polyurethane polymer is a polyurethane flexible block foam or a polyurethane flexible moulded foam.
